(19) United States
(12) Patent Application Publication
(10) Pub. No.: US 2005/0176431 A1
(43) Pub. Date: Aug. 11, 2005

(54) Method for handling key sets during handover

(75) Inventor: Christian Herrero Veron, Lund (SE)

Correspondence Address: JENKENS & GILCHRIST, PC, 1445 ROSS AVENUE, SUITE 3200, DALLAS, TX, 75202, US

(73) Assignee: Telefonaktiebolaget L M Ericsson (publ), Stockholm (SE)

(21) Appl. No.: 11/050,087

(22) Filed: Feb. 3, 2005

Related U.S. Application Data
(60) Provisional application No. 60/544,064, filed on Feb. 11, 2004.

(51) Int. Cl. H04M 1/66

(52) U.S. Cl. 455/436

(57) ABSTRACT

A method of handling key sets includes determining a first key set and ciphering a communication channel between a mobile station communicating in a circuit-switched communication mode and a network using the first key set. The method further includes determining a second key set and responsive to triggering of a handover, sending, to the mobile station, of a security message. Responsive to the step of sending, ciphering the communication channel between the mobile station and the network using the second key set. This Abstract is submitted with the understanding that it will not be used to interpret or limit the scope or meaning of the claims.

### CROSS-REFERENCE TO RELATED APPLICATION

This application claims priority from and incorporates by reference the entire disclosure of U.S. Provisional Patent Application No. 60/544,064, which was filed on Feb. 11, 2004.

### BACKGROUND OF THE INVENTION

1. Technical Field

The present invention relates in general to digital wireless telecommunications and, more particularly, but not by way of limitation, to a method for handling key sets during handover.

2. History of Related Art

One of the most widely-used digital wireless telecommunications standards is the Global System for Mobile communications (GSM) standard, developed by the European Telecommunications Standards Institute. The GSM standard utilizes time division multiple access (TDMA) techniques. A GSM-compliant wireless communication system includes a base station subsystem (BSS). The BSS typically includes a plurality of base transceiver stations (BTSs) for transmitting and receiving radio frequency (RF) signals from a subscriber's mobile station (MS) and at least one base station controller (BSC) for managing radio resource and routing signals to and from the BTSs.

Each BTS is constructed to transmit and receive signals from within a predetermined geographic region called a cell. An intra-system handover, as defined herein, is a process of automatically transferring a communication transaction (e.g., a call) in progress from one cell to another cell to avoid adverse effects of movements of the MS. When the MS travels from one cell to another cell while conducting a telephone call, the BSC switches the MS from one BTS to another, based on signal measurements from the MS, by executing a procedure consistent with the GSM standard. As the MS travels further and further away from an original BTS, handover occurs between adjacent BSCs, and even between neighboring MSCs.

However, when a subscriber desires to switch between a GSM network and another wireless network such as, for example, a network configured to the Universal Mobile Telephone Service (UMTS) standard, which employs recently developed wide-band code division multiple access (W-CDMA) techniques. A UMTS-compliant system typically comprises a core network (CN) and a UMTS Radio Access Network (URAN) that includes a ground-based portion. The ground-based portion of the radio access network (RAN) is often referred to as the UMTS Terrestrial Radio Access Network (UTRAN) and comprises a radio network controller (RNC) and a base station (BS), which have analogous functionality to the BSC and the BTS of a GSM network, respectively. An inter-system handover, as defined herein, is a process of automatically transferring a communication transaction (e.g., a call) in progress from a network operating according to one telecommunications standard to a network operating according to another telecommunications standard (e.g., from GSM to UMTS or vice versa).

Ciphering in today's world is used in many data transmission systems to prevent transmitted data from falling into the hands of an unauthorized user. The ciphering can be performed, for example, by encrypting information to be transmitted in a transmitter, and by decrypting the transmitted information in a receiver. In GSM and UMTS, ciphering is performed on a radio path. A cipher key is set when the network has authenticated a mobile station, but traffic on a channel has not been ciphered. Additionally, in UMTS, there also exists integrity protection of signaling messages. Integrity protection of signaling messages achieves data integrity and origin authentication of signaling data. According to integrity protection, the receiving entity (either the MS or the network) is able to verify that the signaling data has not been modified in an unauthorized way since it was sent by a sending entity (either the MS or the network) and that the data origin of the signaling data received is the one claimed.

Initially, data transmission on a connection between the MS and the base station is not ciphered and/or integrity protected. In the circuit-switched domain, the ciphering and/or integrity protection does not start until the base station sends to the MS a CIPHERING MODE COMMAND message or SECURITY MODE COMMAND message depending upon the mode of operation of the MS. If the MS is operating in the GSM mode, a CIPHERING MODE COMMAND message is sent from the base station to the MS. However, if the MS is operating in the UMTS mode, a SECURITY MODE COMMAND message is sent from the base station to the MS. After the MS has received the CIPHERING MODE COMMAND message or SECURITY MODE COMMAND message, the MS starts to cipher data to be sent and decipher received data, and/or use integrity protection of signaling messages. In the packet-switched domain, data transmission on a connection between the MS and the base station is ciphered and/or integrity protected in a different point in time depending upon the mode of operation of the MS.

In case of a handover (intra-system handover or inter-system handover), a previously-established user data connection or link, such as a voice, a circuit-switched data connection or a packet-switched data connection, continues after the handover. During the handover, data ciphering or encryption should continue uninterrupted in order to meet the security goals of the Third Generation Partnership Project (3GPP). In addition, prior to or after the handover, a new key(s) (cipher key and/or integrity key) may be generated in the MS and the network which has not been utilized yet.

Because of the generation of the cipher key and/or integrity key, the MS and the network can have two key sets. The 3GPP specification currently does not specify which key set should be used for ciphering and/or integrity protection after the handover. Therefore, there is a need for a method of and system for handling key sets during handover.

### SUMMARY OF THE INVENTION

A method of handling key sets includes determining a first key set and ciphering a communication channel between a mobile station communicating in a circuit-switched communication mode and a network using the first key set. The method further includes determining a second key set and responsive to triggering of a handover, sending, to the mobile station, of a security message. Responsive to the step of sending, ciphering the communication channel between the mobile station and the network using the second key set.

A method of handling key sets includes determining a first key set and ciphering a communication channel between a mobile station communicating in a packet-switched communication mode and a network using the first key set. The method further includes determining a second key set and responsive to triggering a handover, ciphering the communication channel between the mobile station and the network using the second key set.

### BRIEF DESCRIPTION OF THE DRAWINGS

A more complete understanding of the present invention may be obtained by reference to the following Detailed Description of Exemplary Embodiments of the Invention, when taken in conjunction with the accompanying Drawings, wherein:

FIG. 1 is a block diagram illustrating a GSM network interfaced with a UMTS network;

FIG. 2 is a block diagram illustrating a mobile station (MS);

FIG. 3 illustrates a signal flow between the mobile station and the UMTS network during an intra-system handover while the mobile station is communicating in a circuit-switched (CS) domain;

FIG. 4A illustrates a signal flow between the mobile station and the GSM network during an intra-system handover while the mobile station is communicating in the circuit-switched (CS);

FIG. 4B illustrates a signal flow between the mobile station and the GSM network during an inter-system handover while the mobile station is communicating in the circuit-switched (CS) domain;

FIG. 4C illustrates a signal flow between the mobile station and the UMTS network during an inter-system handover while the mobile station is communicating in the circuit-switched (CS) domain;

FIG. 5 illustrates a signal flow between the mobile station and the UMTS network while the mobile station is communicating in a packet-switched (PS) domain; and

FIG. 6 illustrates a signal flow between the mobile station and the GSM network while the mobile station is communicating in the packet-switched (PS) domain.

### DETAILED DESCRIPTION OF EXEMPLARY EMBODIMENTS OF THE INVENTION

Embodiment(s) of the invention will now be described more fully with reference to the accompanying Drawings. The invention may, however, be embodied in many different forms and should not be construed as limited to the embodiment(s) set forth herein. The invention should only be considered limited by the claims as they now exist and the equivalents thereof.

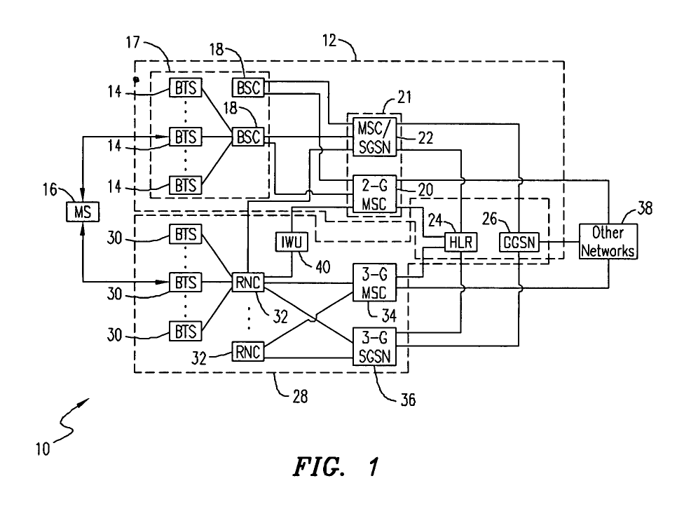

FIG. 1 illustrates a wireless telecommunications system 10. The system 10 includes a GSM network 12 having a radio access network portion 17 and a core network portion 21. The radio access network portion comprises a plurality of base transceiver stations (BTSs) 14 for transmitting and receiving voice and data calls from a mobile station (MS) 16, and a base station controller (BSC) 18. The BSC 18 manages radio resources by establishing, maintaining, and releasing communication transactions between the MS 16 and the core network portion. Each BSC 18 is connected to a predetermined number of BTSs 14.

The core network portion (e.g., a land-based wireline portion) comprising a mobile switching center (MSC) 20 (e.g. a second-generation or 2-G MSC) for controlling voice calls between the wireless and wireline portions of the network. The core network portion may include another core network node, such as a Serving GPRS Support Node (SGSN) or a MSC/SGSN 22 (i.e. a core network node with SGSN and MSC capabilities). The core network further includes a circuit switched domain for processing, for example, voice calls and a packet switched domain for supporting bursty, high speed data transfers such as, for example, e-mail messages and web browsing.

The circuit-switched portion includes a mobile-services switching center (MSC) that switches or connects telephone calls between the radio-access network (i.e., the BSS) through a BSC, and a subscriber's public switched telephone network (PSTN) or a public land mobile network (PLMN).

The packet-switched portion, also known as General Packet Radio Service (GPRS), includes a Serving GPRS Support Node (SGSN), similar to the MSC of the voice-portion of the system, for serving and tracking the MS, and a Gateway GPRS Support Node (GGSN) for establishing connections between packet-switched networks and a mobile station. The SGSN may also contain subscriber data useful for establishing and handing over call connections.

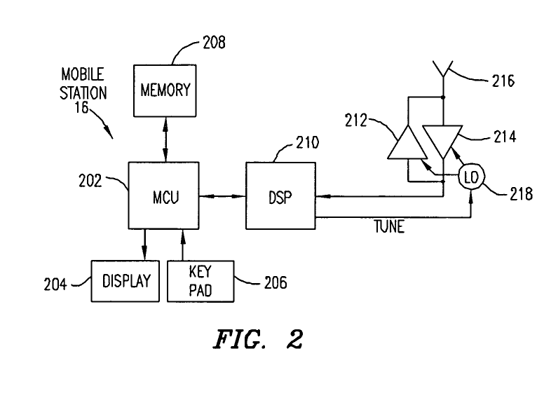

The MSC 20 is coupled to a VLR (not explicitly shown) that temporarily stores the location of the MS 16. Details of the MS 16 will be described with reference to FIG. 2. The MSC 20, and SGSN or MSC/SGSN 22 are connected to a home location register (HLR) 24, which includes a database containing data specific to a subscriber, such as services available to the subscriber and location of the subscriber (i.e., address of the MSC/VLR). The SGSN or MSC/SGSN 22 is also connected to a Gateway GPRS Support Node (GGSN) 26 for accessing other packet networks.

FIG. 1 further illustrates a UMTS network 28 comprising a plurality of base stations 26 for receiving and transmitting calls to the MS 16. A predefined number of BSs 30 are connected to a radio network controller (RNC) 32 that interfaces with an MSC (e.g. a “third-generation or 3-G MSC”) 34 through a conventional Iu interface (not explicitly shown). Similar to the MSC 20 of the GSM network 12, MSC 34 also accesses a HLR, which may be the same HLR (i.e. HLR 24) as that used by the GSM network, to retrieve subscriber-specific data. The RNC 32 is preferably connected to a SGSN (e.g. a third-generation or 3-G SGSN) 36 for high-speed data transfers, which is connected to packet networks 38 through a Gateway GPRS Support Node (GGSN). As shown, the GGSN of the UMTS network 28 may also be the same GGSN 26 used by the SGSN 22 of the GSM network 12.

An interworking unit (IWU) 40 couples the RNC 32 of UMTS network 28 to the second-generation MSC 20 of the GSM network 12. The IWU 40 interfaces with the MSC 22 through the A-interface and with the RNC 32 through the Iu interface. It is contemplated that the GSM network 12 may include a third-generation or 3-G MSC constructed to communicate with a BSC 18 using the A-interface and the RNC 32 using the Iu interface.

FIG. 2 illustrates a block diagram of the MS 16. The MS 16, for example, may be a handheld radio telephone, such as a cellular telephone or a personal communicator. The MS 16 typically includes a data processor such as a microcontrol unit (MCU) 202 having an output coupled to an input of a display 204 and an input coupled to a keyboard or keypad 206. The MCU 202 is coupled to some type of a memory 208, including a read-only memory (ROM) for storing an operating program, as well as a random access memory (RAM) for temporarily storing required data. A separate removable SIM or USIM (not shown) can be provided as well for storing subscriber-related information.

The ROM of the MS 16 typically stores a program that provides a suitable user interface (UI), via display 204 and keypad 206. Although not shown, a microphone and speaker are typically provided for enabling a user to conduct voice calls in a convenient manner. The MS 16 also contains a wireless section that includes a digital signal processor (DSP) 210, as well as a wireless transceiver that includes a transmitter 212 and a receiver 214, both of which are coupled to an antenna 216. At least one oscillator 218, such as a frequency synthesizer, is provided for tuning the transceiver.

The ROM of the MS 16 stores a program that enables the MS 16 to receive and process handover of the MS 16 from a cell within the GSM network 12 to another cell in the GSM network 12. The ROM also stores a program to process a inter-system change message which enables the MS 16 from moving from for example, UMTS network 28 to another network, such as a GSM network 12.

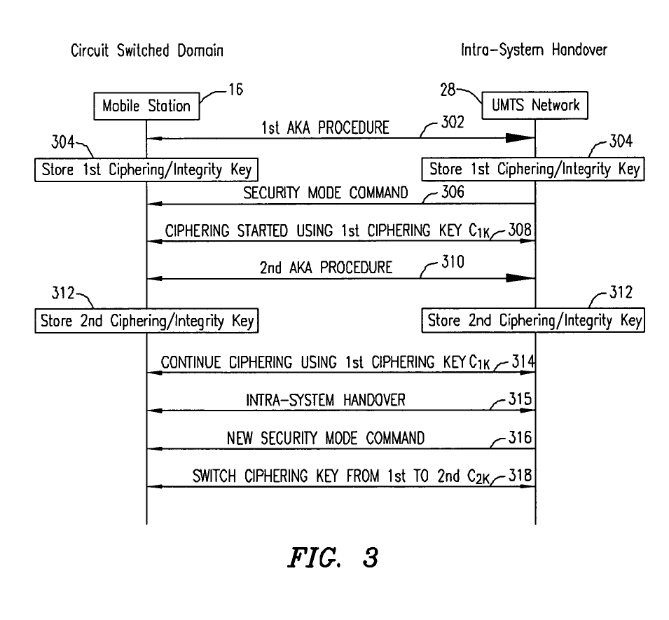

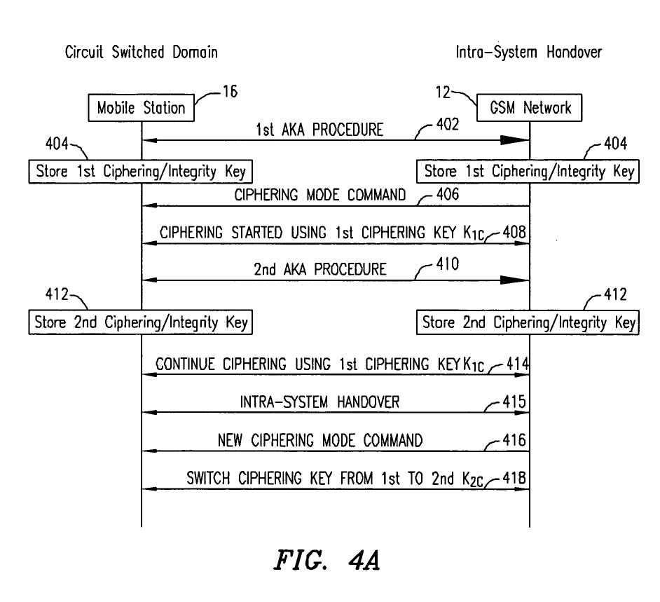

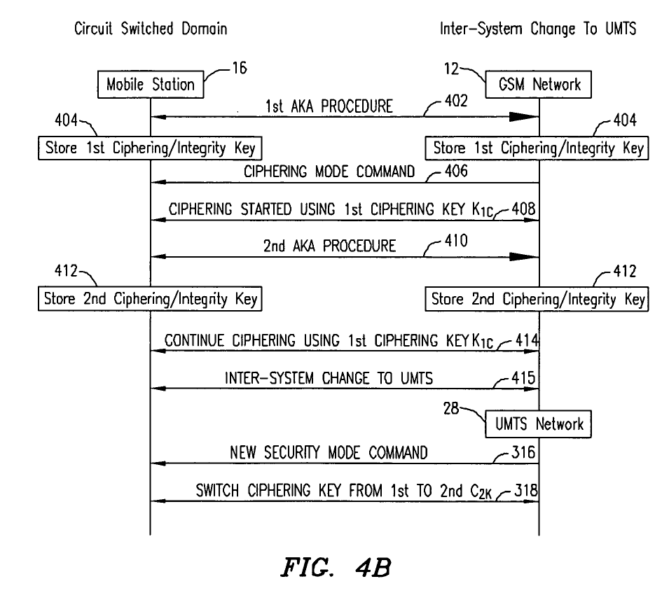

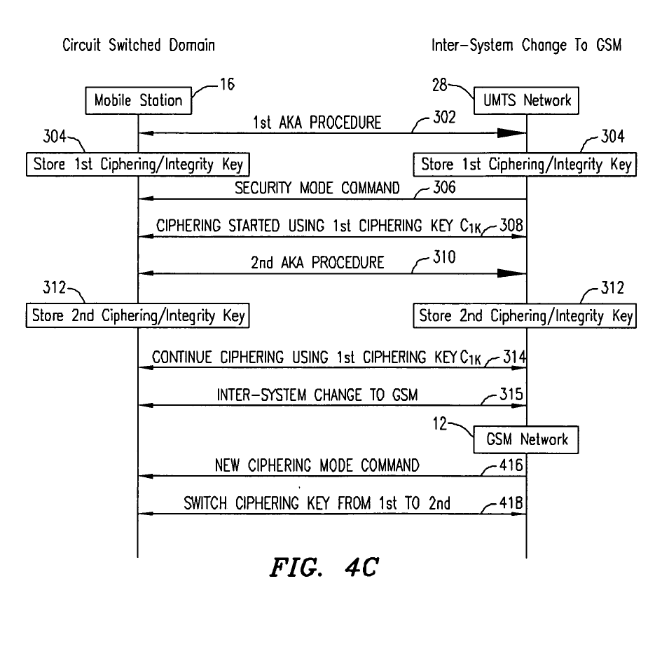

FIGS. 3 and 4A-4C illustrate a signal flow between the MS 16 and the UMTS and the GSM networks (28, 12) while the MS 16 is communicating in the circuit-switched (CS) domain. A first authentication and key agreement (AKA) procedure (302, 402) between the MS 16 and the network (28, 12) occurs. The MS 16 and the network (28, 12) by means of the AKA procedure (302, 402) are required to achieve mutual authentication and agree on a ciphering key (Kc when the MS 16 is communicating with the GSM network (12) or CK when MS 16 is communicating with the UMTS network (28)) and/or integrity key (IK) before exchanging information. Therefore, the AKA procedure determines a key set which is utilized to cipher or encrypt a communication channel between the MS 16 and the network (28, 12), and to integrity protect signaling messages. The Kc and CK are the ciphering keys used to cipher or encrypt a communication channel in GSM and UMTS networks (12, 28), respectively, while IK is the integrity key used only in UMTS (28). The MS 16 and the network (GSM 12 or UMTS 28) can derive the CK and IK from the Kc by means of a conversion function. In addition, the MS and the network can derive the Kc from the CK and IK. The derived ciphering and integrity keys are, for example, used during inter-system change. During the first AKA procedure, the MS 16 and the network agree to a first key set (304, 404) (K₁c and derived C₁K or C₁K, I₁K and derived K₁c); however, the agreed keys are not yet used to cipher information and/or integrity protect signaling messages.

If the MS 16 is operating in the UMTS mode, the UMTS network (28) sends a SECURITY MODE COMMAND message (306) to the MS 16. The SECURITY MODE COMMAND message (306) may indicate to the MS 16 that the agreed C₁K has to be used in order to cipher a communication channel between the MS 16 and the UMTS network (28). The SECURITY MODE COMMAND message (306) may indicate to the MS 16 that the agreed integrity key (I₁K) has to be used in order to start integrity protection of signaling messages between the MS 16 and the UMTS network (28). After the MS 16 receives the SECURITY MODE COMMAND message (306), ciphering of the communication channel between the MS 16 and the UMTS network (28) is initiated using the agreed C₁K (308).

However, if the MS 16 is operating in the GSM mode, the GSM network (12) sends a CIPHERING MODE COMMAND message (406) to the MS 16. The CIPHERING MODE COMMAND message (406) may indicate to the MS 16 that the agreed K₁c during the first AKA procedure has to be used in order to cipher a communication channel between the MS 16 and the GSM network (12). After the MS 16 receives the CIPHERING MODE COMMAND message (406), ciphering of the communication channel between the MS 16 and the GSM network (12) is initiated using the agreed K₁c (408).

After initiating ciphering (308, 408) of the communication channel between the MS 16 and the GSM or UMTS network (12, 28) using the agreed K₁c or C₁K, the GSM or UMTS network (12, 28) may initiate a second AKA procedure (310, 410) between the MS 16 and the GSM or UMTS network (12, 28) for agreeing on a second key set (K₂c and derived C₂K, I₂K or C₂K, I₂K and derived K₂c). During the second AKA procedure (310, 410), the MS 16 and the GSM or UMTS network (12, 28) agree upon a second key set (312, 412) (K₂c and derived C₂K, I₂K or C₂K, I₂K and derived K₂c); however, even if an agreement is reached, the K₂c or C₂K is not yet used to cipher information, but the second key set is stored in the MS 16 and the GSM network (12) or the UMTS network (28) (312, 412). Ciphering of the communication channel between the MS 16 and the GSM or UMTS network (12, 28) is continued using the first key set K₁c or C₁K (314, 414). The same is applicable for the I₂K which is not yet used to integrity protect signaling messages. Integrity protection of signaling messages between the MS and the network is continued using the first integrity key I₁K.

In case of an intra-system handover (FIGS. 3 and 4A) or an inter-system handover (FIGS. 4B-4C), ciphering of a communication channel between the MS 16 and the GSM or UMTS network (12, 28) is continued using the first key set K₁c or C₁K (414, 314). Even though the second key set has been agreed upon and stored in the MS 16 and the GSM or UMTS network (12, 28), the second key set K₂c or C₂K is not yet used for ciphering. The MS 16 and the GSM or UMTS network (12, 28) continue to use the first key set (408, 308) until a new valid SECURITY MODE COMMAND message (316) (for a MS operating in the UMTS mode) or the CIPHERING MODE COMMAND message (416) (for a MS operating in the GSM mode) is sent to the MS 16 from the GSM or UMTS network (12, 28). After the MS 16 receives the new valid CIPHERING MODE COMMAND message (416) or the SECURITY MODE COMMAND message (316) (depending upon the mode of operation of the MS 16), the first key set K₁c or C₁K is replaced by the second key set K₂c or C₂K (418, 318) for ciphering the communication channel between the MS 16 and the GSM or UMTS network (12, 28). The same is applicable in case of UMTS for integrity protection of signaling messages. The MS 16 and the UMTS network (28) continue to use the first integrity key I₁K until a new valid SECURITY MODE COMMAND message is sent to the MS 16 from the UMTS network (28). After the MS 16 receives the new valid SECURITY MODE COMMAND message, the first integrity key I₁K is replaced by the second integrity key set I₂K for integrity protection of signaling messages between the MS 16 and the UMTS network (28).

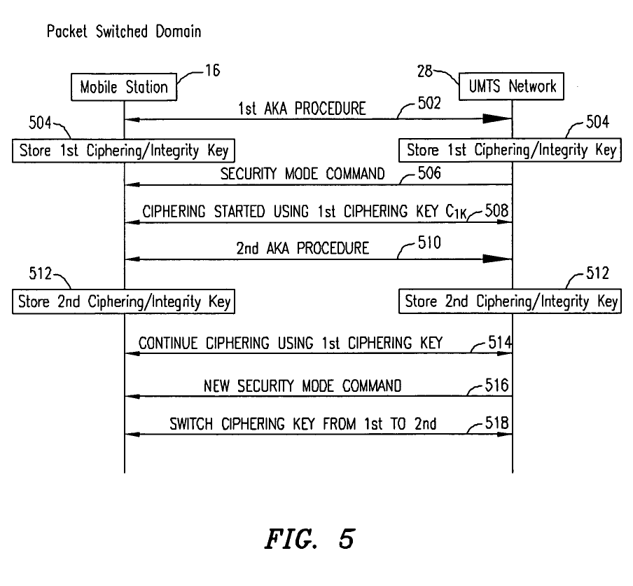

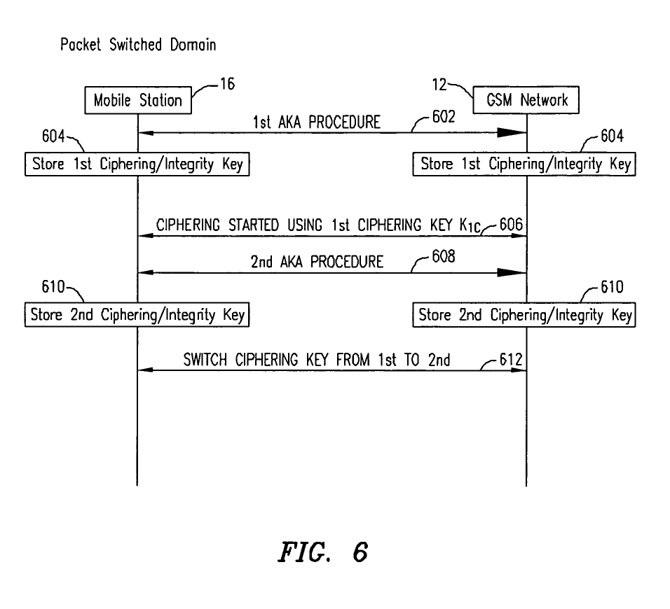

FIGS. 5 and 6 illustrate a signal flow between the MS 16 and the UMTS and GSM networks (28, 12) while the MS 16 is communicating in the packet-switched (PS) domain. A first authentication and key agreement (AKA) procedure (502, 602) between the MS 16 and the network occurs (28, 12). The MS 16 and the network are required by the AKA procedure (502, 602) to achieve mutual authentication and agree on ciphering key (Kc or CK) and/or integrity key (IK) before exchanging information. Therefore, the AKA procedure determines a key set which is utilized to cipher or encrypt a communication channel between the MS 16 and the network (28, 12), and to integrity protect signaling messages.

The Kc and CK are the ciphering keys used to cipher or encrypt a communication channel in GSM and UMTS (12, 28), respectively, while IK is the integrity key used only in UMTS. The MS 16 and the network (GSM (12) or UMTS (28)) can derive the CK and IK from the Kc by means of a conversion function. In addition, the MS and the network (12, 28) can derive the Kc from the CK and IK. The derived ciphering and integrity keys are, for example, used during inter-system change. During the first AKA procedure (502, 602), the MS 16 and the network (12, 28) agree to a first key set (504, 604) (K₁c and derived C₁K, I₁K or C₁K, I₁k and derived K₁c); however, the agreed keys are not yet used to cipher information and/or integrity protect signaling messages.

The AKA procedure (502, 602) determines a first key set which is utilized to cipher or encrypt a communication channel between the MS 16 and the network (12, 28). During the first AKA procedure (502, 602), the MS 16 and the network (12, 28) agree upon the first key set (504, 604), however, depending upon the mode of operation of the MS 16, the ciphering key K₁c or C₁K is used either immediately to cipher information or not immediately used.

If the MS 16 is operating in the UMTS mode, the UMTS network (28) sends a SECURITY MODE COMMAND message to (506) the MS 16. The SECURITY MODE COMMAND message (506) may indicate to the MS 16 that the agreed C₁K should be used in order to cipher a communication channel between the MS 16 and the UMTS network (28). After the MS 16 receives the SECURITY MODE COMMAND message (506), ciphering of the communication channel between the MS 16 and the UMTS network (28) is initiated using the agreed C₁K (508).

After initiating ciphering (508) of the communication channel between the MS 16 and the UMTS network (28) using the agreed C₁K, the UMTS network may initiate a second AKA procedure (510) between the MS 16 and the UMTS network (28) for agreeing on a second key set (C₂K, I₂K and derived K₂c) (512). During the second AKA procedure (510), the MS 16 and the UMTS network (28) may agree upon the second key set (C₂K, I₂K and derived K₂c); however, even if an agreement is reached, the C₂K is not yet used to cipher information but the second key set is stored in the MS 16 and the UMTS network (28) (512). Ciphering of the communication channel between the MS 16 and the UMTS network (28) is continued using the first key set C₁K (514). The MS 16 and the UMTS network (28) continue to use the first key set C₁K (514) until a new valid SECURITY MODE COMMAND message (516) is sent from the UMTS network (28). After the MS 16 receives the new valid SECURITY MODE COMMAND message (516), the first key set C₁K (514) is replaced by the second key set C₂K (518) for ciphering the communication channel between the MS 16 and the UMTS network (28). The same is applicable for the I₂K, which is not yet used to integrity protect signaling messages. Integrity protection of signaling messages between the MS and the network is continued using the first integrity key I₁K until a new valid SECURITY MODE COMMAND message is sent to the MS 16 from the UMTS network (28). After the MS 16 receives the new valid SECURITY MODE COMMAND message, the first integrity key I₁K is replaced by the second integrity key set I₂K for integrity protection of signaling messages between the MS 16 and the UMTS network (28).

However, if the MS 16 is operating in the GSM mode, the MS 16 and the GSM network (12) start to use the agreed K₁c to cipher a communication channel between the MS 16 and the GSM network (12). Therefore, ciphering of the communication channel between the MS 16 and the GSM network (12) is initiated using the agreed K₁c (606).

After initiating ciphering (606) of the communication channel between the MS 16 and the GSM network (12) using the agreed K₁c, the GSM network (12) may initiate a second AKA procedure (608) between the MS 16 and the GSM network (12) for agreeing on a second key set (K₂c) (610). During the second AKA procedure (608), the MS 16 and the GSM network (12) agree upon the second key set (K₂c). Responsive to the step of agreeing upon the second key set (K₂c and derived C₂K, I₂K), in the GSM mode, ciphering of the communication channel between the MS 16 and the GSM network (12) (612) is performed using the second key set (K₂c). For example, the K₁c is immediately replaced by the K₂c to cipher the communication channel between the MS 16 and the GSM network (12) (612).

In case of an inter-system handover to GSM, ciphering of the communication channel between the MS 16 and the GSM network (12) (612) is performed using the second key set (K₂c). For example, the C₁K is immediately replaced by the K₂c to cipher the communication channel between the MS 16 and the GSM network (12). In the PS domain, if the MS 16 operates in the UMTS mode and an inter-system handover to GSM mode occurs, the MS 16 and the GSM network (12) do not wait before switching to the second key.

It should be emphasized that the terms “comprise”, “comprises”, and “comprising”, when used herein, are taken to specify the presence of stated features, integers, steps, or components, but do not preclude the presence or addition of one or more other features, integers, steps, components or groups thereof.

The previous Detailed Description is of embodiment(s) of the invention. The scope of the invention should not necessarily be limited by this Description. The scope of the invention is instead defined by the following claims and the equivalents thereof.

1. A method of handling key sets, the method comprising:
determining a first key set;
ciphering a communication channel between a mobile station communicating in a circuit-switched communication mode and a network using the first key set;
determining a second key set;
responsive to triggering of a handover, sending, to the mobile station, of a security message; and
responsive to the step of sending, ciphering the communication channel between the mobile station and the network using the second key set.

2. The method of claim 1, wherein the handover is an intra-system handover.

3. The method of claim 2, wherein the steps of the intra-system handover are performed within a GSM network.

4. The method of claim 2, wherein the steps of the intra-system handover are performed within a UMTS network.

5. The method of claim 1, wherein the handover is an inter-system handover.

6. The method of claim 5, wherein the inter-system handover is between a GSM and a UMTS network.

7. The method of claim 1, wherein the security message is a SECURITY MODE COMMAND when the mobile station is operating in a UMTS mode.

8. The method of claim 1, wherein the security message is a CIPHERING MODE COMMAND when the mobile station is operating in a GSM mode.

9. A method of handling key sets, the method comprising:
determining a first key set;
ciphering a communication channel between a mobile station communicating in a packet-switched communication mode and a network using the first key set;
determining a second key set; and
responsive to triggering of a handover, ciphering the communication channel between the mobile station and the network using the second key set.

10. The method of claim 9, wherein the handover is an inter-system handover.

11. The method of claim 10, wherein the inter-system handover is between a UMTS network and a GSM network.

12. The method of claim 9, wherein the handover is an intra-system handover.

13. The method of claim 12, wherein the steps of the intra-system handover are performed within a GSM network.

14. The method of claim 12, wherein the steps of the intra-system handover are performed within a UMTS network.

15. The method of claim 9, wherein the step of ciphering the communication channel between the mobile station and the network using the second key set is initiated immediately after the step of triggering the handover.
